(19) United States
(12) Patent Application Publication
(10) Pub. No.: US 2005/0083266 A1
(43) Pub. Date: Apr. 21, 2005

(54) Plasma display panel and driving method thereof

(76) Inventor: Sang-Chul Kim, Suwon-si (KR)

Correspondence Address: McGuireWoods LLP, Suite 1800, 1750 Tysons Boulevard, McLean, VA, 22102, US

(21) Appl. No.: 10/968,160

(22) Filed: Oct. 20, 2004

(30) Foreign Application Priority Data
Oct. 21, 2003 (KR) 10-2003-0073535

(51) Int. Cl. G09G 3/28

(52) U.S. Cl. 345/63

(57) ABSTRACT

A method for driving a plasma display panel including a first electrode, a second electrode, and an address electrode utilizing a plurality of subfields, including a first subfield and a second subfield. A voltage difference between the address electrode and the first electrode in a selected discharge cell in an address period of the first subfield, and a voltage difference between the address electrode and the first electrode in the selected discharge cell in the address period of the second subfield, are different.

### CROSS REFERENCE TO RELATED APPLICATION

This application claims priority to and the benefit of Korean Patent Application No. 10-2003-0073535, filed on Oct. 21, 2003, which is hereby incorporated by reference for all purposes as if fully set forth herein.

### BACKGROUND OF THE INVENTION

1. Field of the Invention

The present invention relates to a driving method of a plasma display panel (PDP). More specifically, the present invention relates to a driving method of a PDP having reduced power consumption in an address period.

2. Discussion of the Related Art

Various flat displays such as the liquid crystal display (LCD), the field emission display (FED), and the PDP have been developed. Of these, the PDP has a higher resolution, a higher rate of emission efficiency, and a wider view angle. Accordingly, the PDP is being considered as the primary substitute for the conventional cathode ray tube (CRT), especially for the large-sized displays of greater than forty inches.

The PDP shows characters or images using plasma generated by gas discharge, and it may include hundreds of thousands to millions of pixels arranged in a matrix format. PDPs are either direct current (DC) PDPs or alternating current (AC) PDPs depending upon the applied driving voltage waveforms and discharge cell structure.

Electrodes of the DC PDP are exposed in a discharge space, and current flows in the discharge space when a voltage is applied to them. Therefore, DC PDPs require a resistor for current limitation. To the contrary, a dielectric layer covers the electrodes of the AC PDP and limits the current because of naturally formed capacitance components. Also, the dielectric layer protects the electrodes from ion impulses due to discharging, which provides the AC PDP with a longer lifespan than the DC PDP.

FIG. 1 shows a partial perspective view of a conventional AC PDP.

As shown in FIG. 1, parallel pairs of scan electrodes 4 and sustain electrodes 5 are formed on a first glass substrate 1, and are covered with a dielectric layer 2 and a protection film 3. A plurality of address electrodes 8, covered with an insulator layer 7, is established on a second glass substrate 6. Barrier ribs 9 are formed on the insulator layer 7 in between, and in parallel with, the address electrodes 8, and phosphors 10 are formed on the surface of the insulator layer 7 and on the sides of the barrier ribs 9. The first and second glass substrates 1 and 6 are sealed together to form a discharge space 11 therebetween, and the scan electrodes 4 and the sustain electrodes 5 are arranged orthogonally to the address electrodes 8. A discharge space 11 between an address electrode 8 and a pair of the scan electrode 4 and the sustain electrode 5 forms a discharge cell 12.

FIG. 2 schematically shows a typical electrode arrangement of the AC PDP of FIG. 1.

As shown in FIG. 2, the electrodes of the PDP are arranged in an m×n matrix format. The address electrodes A₁ to Aₘ are arranged in the column direction, and n scan electrodes Y₁ to Yₙ (Y electrodes) and n sustain electrodes X₁ to Xₙ (X electrodes) are alternately arranged in the row direction. The discharge cell 12 in FIG. 2 corresponds to the discharge cell 12 in FIG. 1.

FIG. 3 shows a conventional driving waveform diagram of a PDP.

According to the PDP driving method shown in FIG. 3, each subfield comprises a reset period, an address period, and a sustain period.

In the reset period, wall charges of a previous sustain-discharging are erased, and wall charges are generated so as to stably perform the next address period.

In the address period, cells that are to be turned on are selected, and wall charges accumulate to the selected cells.

In the sustain period, a discharge for displaying images on the selected cells is performed.

Wall charges are formed on a wall of a discharge cell neighboring each electrode, and they accumulate to electrodes. Although the wall charges do not actually contact the electrodes, it is described below as the wall charges being “generated”, “formed”, or “accumulated” thereon. Additionally, the wall voltage is a potential difference formed across the gas in the discharge cells by the wall charges.

A reset waveform, applied during the reset period of each subfield, may apply a rising ramp to Y electrodes, generate weak discharging, apply a falling ramp to the Y electrodes, and uniformly establish the wall charge status of the cells. Unselected cells from a previous address period generate no discharging in the sustain period, and priming particles may be maintained after the sustain period. Therefore, it may not be necessary for the rising ramp to be applied in the reset period to generate the wall charge.

As disclosed in U.S. Pat. No. 6,294,875, a reset operation may be performed with a main reset waveform comprising a rising ramp and a falling ramp in the reset period of the first subfield, and a selective reset waveform for applying the falling ramp may be applied in a predetermined period of the next subfield. This conventional driving waveform is shown in FIG. 4.

However, as to the conventional driving waveform shown in FIG. 4, a voltage applied to the address electrode in the address period of the subfield for applying the selective reset waveform, and a voltage applied to the address electrode in the address period of the subfield for applying the main reset waveform, are equal. Hence, power may be wasted in the address period.

### SUMMARY OF THE INVENTION

The present invention provides a PDP having reduced power consumption in an address period, and a driving method of the same.

Additional features of the invention will be set forth in the description which follows, and in part will be apparent from the description, or may be learned by practice of the invention.

The present invention discloses a method for a plasma display panel including a first electrode and an address electrode, comprising driving the plasma display panel with a plurality of subfields including a first subfield and a second subfield. A voltage difference between the address electrode and the first electrode in a selected discharge cell in an address period of the first subfield, and a voltage difference between the address electrode and the first electrode in the selected discharge cell in the address period of the second subfield, are different.

The present invention also discloses a PDP comprising a first substrate, a second substrate, an address electrode arranged on the first substrate, and a first electrode arranged on the second substrate. A discharge cell is formed by the address electrode and the first electrode. A driving circuit provides a driving signal to the first electrode and the address electrode in a reset period, an address period, and a sustain period, and the plasma display panel is driven with a plurality of subfields comprising a first subfield and a second subfield. In the first subfield, the driving circuit applies a reset pulse comprising a rising ramp and a falling ramp to the first electrode in the reset period, and applies a first voltage to the address electrode in a selected discharge cell in the address period. In the second subfield, the driving circuit applies a reset pulse comprising a falling ramp without a rising ramp to the first electrode in the reset period, and applies a second voltage to the address electrode in the selected discharge cell in the address period. The first voltage and the second voltage are different.

The present invention also discloses a PDP comprising a first substrate, a second substrate, an address electrode arranged on the first substrate, and a first electrode arranged on the second substrate. A discharge cell is formed by the address electrode and the first electrode. A driving circuit provides a driving signal to the first electrode and the address electrode in a reset period, an address period, and a sustain period, and the plasma display panel is driven with a plurality of subfields comprising a first subfield and a second subfield. In the first subfield, the driving circuit applies a reset pulse comprising a rising ramp and a falling ramp to the first electrode in the reset period, and applies a first voltage to the first electrode in a selected discharge cell in the address period. In the second subfield, the driving circuit applies a reset pulse comprising a falling ramp without a rising ramp to the first electrode in the reset period, and applies a second voltage to the first electrode in the selected discharge cell in the address period. The first voltage and the second voltage are different

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of the specification, illustrate embodiments of the invention and together with the description serve to explain the principles of the invention.

FIG. 1 shows a partial perspective view of conventional AC PDP.

FIG. 2 shows a typical electrode arrangement of an AC PDP.

FIG. 3 shows a conventional driving waveform diagram of a PDP.

FIG. 4 shows a conventional driving waveform diagram of a PDP.

FIG. 5 shows a driving waveform diagram of a PDP according to a first exemplary embodiment of the present invention.

FIG. 6 shows a driving waveform diagram of a PDP according to a second exemplary embodiment of the present invention.

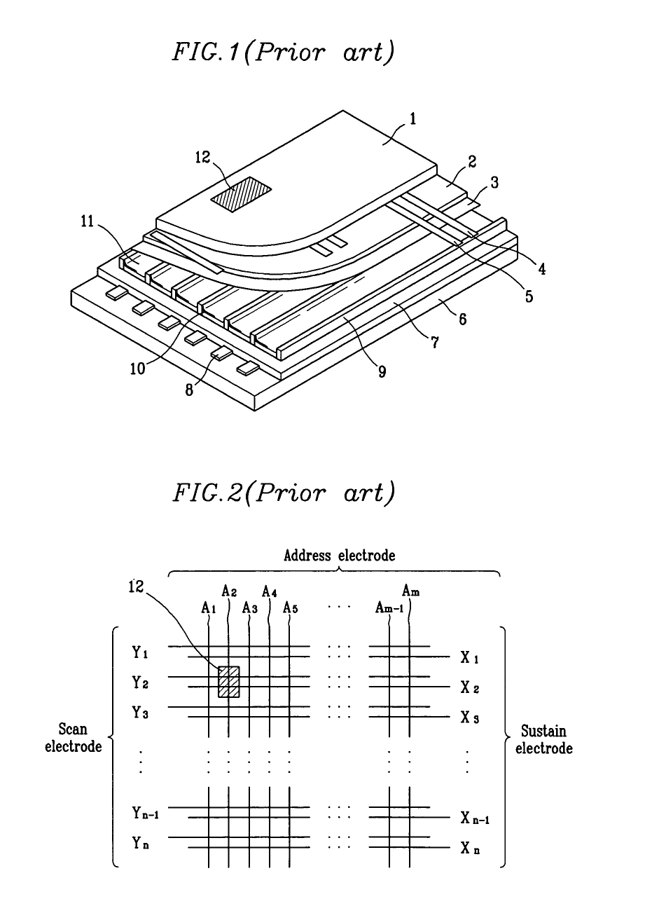

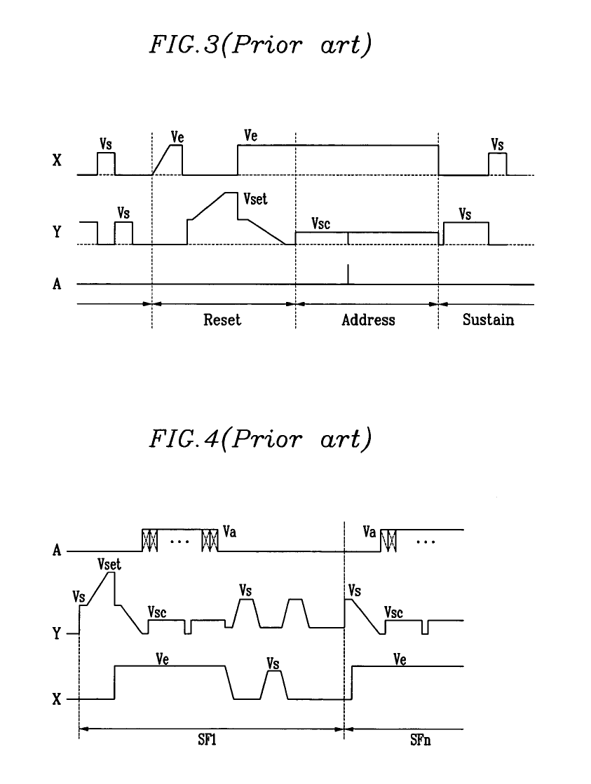

### DETAILED DESCRIPTION OF THE ILLUSTRATED EMBODIMENTS

The following detailed description shows and describes exemplary embodiments of the present invention, simply by way of illustration of the best mode contemplated by the inventor of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

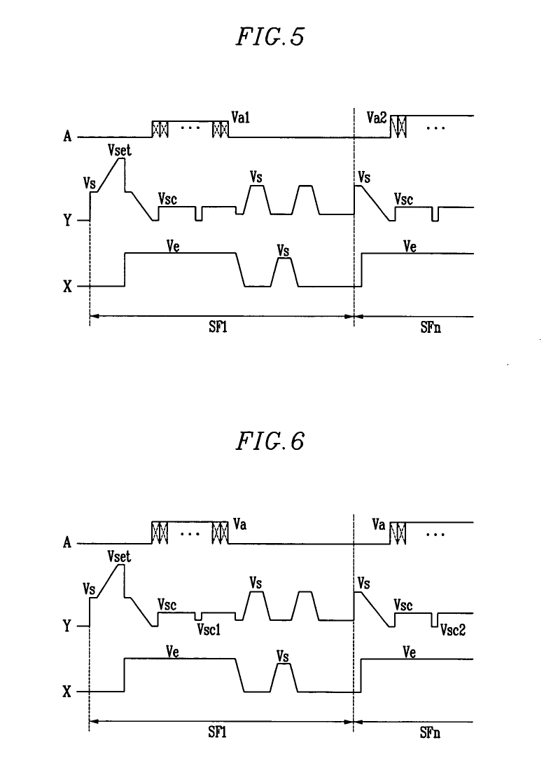

FIG. 5 shows a driving waveform diagram of a PDP according to the first exemplary embodiment of the present invention.

As shown in FIG. 5, a voltage Vₐ₁ applied to an address electrode A of a discharge cell selected in the address period of a subfield SF₁ is lower than a voltage Vₐ₂ applied to the address electrode A of a discharge cell selected in the address period of a subfield SFₙ.

In the reset period of the subfield SF₁, the reset operation is performed by a main reset waveform comprising a rising ramp and a falling ramp applied to the Y electrodes, thereby sufficiently generating priming particles in the discharge cells because of the rising ramp. On the other hand, in the reset period of the subfield SFₙ, the reset operation is performed by the falling ramp without the rising ramp, which may generate less priming particles than the reset waveform of the subfield SF₁ including the rising ramp.

Therefore, following the main reset waveform with a rising ramp, an addressing operation may be performed when the address voltage Vₐ₁ of the subfield SF₁ is lower than the address voltage Vₐ₂ of the subfield SFₙ.

For example, when the address voltage Vₐ₂ of the subfield SFₙ is about 80V, the addressing operation may be performed properly in the address period of the subfield SF₁ when the address voltage Vₐ₁ is about 65V.

While the first exemplary embodiment of the present invention provides for different address voltages applied to the address electrodes in the address period, as discussed below, it may also be possible to apply different scan voltages to the Y electrode.

FIG. 6 shows a driving waveform diagram of a PDP according to a second exemplary embodiment of the present invention.

As shown in FIG. 6, a voltage V_{sc1} applied to the Y electrode in the discharge cell selected in the address period of the subfield SF₁ is higher than a voltage V_{sc2} applied to the Y electrode in the address period of the subfield SFₙ.

Since the priming particles may be generated sufficiently by the rising ramp applied in the reset period in the subfield SF₁, the addressing operation may be performed properly when the voltage difference between the address electrode A and the Y electrode in the first subfield SF₁ is less than that of the subfield SFₙ.

According to the exemplary embodiments of the present invention, power consumption may be reduced when the voltage difference between the address electrode A and the Y electrode is less in the first subfield SF₁ than in later subfields SFₙ due to the application of the rising ramp reset waveform in the first subfield SF₁.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for driving a plasma display panel including a first electrode and an address electrode, comprising:
driving the plasma display panel with a plurality of subfields including a first subfield and a second subfield; and
allowing a voltage difference between the address electrode and the first electrode in a selected discharge cell in an address period of the first subfield, and a voltage difference between the address electrode and the first electrode in the selected discharge cell in the address period of the second subfield, to be different.

2. The method of claim 1, further comprising:
applying a reset pulse comprising a rising ramp and a falling ramp in a reset period in the first subfield; and
applying a reset pulse comprising a falling ramp without a rising ramp in the reset period for the second subfield.

3. The method of claim 1, wherein a magnitude of a first voltage applied to the address electrode in the selected discharge cell in the address period of the first subfield is different from a magnitude of a second voltage applied to the address electrode in the selected discharge cell in the address period of the second subfield.

4. The method of claim 3, wherein the magnitude of the first voltage is less than the magnitude of the second voltage.

5. The method of claim 1, wherein a magnitude of a third voltage applied to the first electrode in the selected discharge cell in the address period of the first subfield is different from a magnitude of a fourth voltage applied to the first electrode in the selected discharge cell in the address period of the second subfield.

6. The method of claim 5, wherein the magnitude of the third voltage is greater than the magnitude of the fourth voltage.

7. A plasma display panel (PDP), comprising:
a first substrate and a second substrate;
an address electrode arranged on the first substrate;
a first electrode arranged on the second substrate;
a discharge cell formed by the address electrode and the first electrode; and
a driving circuit for providing a driving signal to the first electrode, and the address electrode in a reset period, an address period, and a sustain period,
wherein the PDP is driven with a plurality of subfields comprising a first subfield and a second subfield,
wherein the driving circuit, in the first subfield, applies a reset pulse comprising a rising ramp and a falling ramp to the first electrode in the reset period, and applies a first voltage to the address electrode in a selected discharge cell in the address period; and
wherein the driving circuit, in the second subfield, applies a reset pulse comprising a falling ramp without a rising ramp to the first electrode in the reset period, and applies a second voltage to the address electrode in the selected discharge cell in the address period;
wherein the first voltage and the second voltage are different.

8. The PDP of claim 7, wherein the first voltage is less than the second voltage.

9. A plasma display panel (PDP), comprising:
a first substrate and a second substrate;
an address electrode arranged on the first substrate;
a first electrode arranged on the second substrate;
a discharge cell formed by the address electrode and the first electrode; and
a driving circuit for providing a driving signal to the first electrode, and the address electrode in a reset period, an address period, and a sustain period,
wherein the PDP is driven with a plurality of subfields comprising a first subfield and a second subfield,
wherein the driving circuit, in the first subfield, applies a reset pulse comprising a rising ramp and a falling ramp to the first electrode in the reset period, and applies a first voltage to the first electrode in a selected discharge cell in the address period;
wherein the driving circuit, in the second subfield, applies a reset pulse comprising a falling ramp without a rising ramp to the first electrode in the reset period, and applies a second voltage to the first electrode in the selected discharge cell in the address period; and
wherein the first voltage and the second voltage are different.

10. The PDP of claim 9, wherein the first voltage is greater than the second voltage.
